(19) United States
(12) Patent Application Publication
(10) Pub. No.: US 2012/0004947 A1
(43) Pub. Date: Jan. 5, 2012

(54) INTEGRATED DATA MANAGEMENT FOR NETWORK SERVICE PROVIDERS AND CUSTOMERS

(75) Inventors: Edmund G. DOMBROWSKI, Hamilton, VA (US); Scott Bollig, Boston, MA (US)

(73) Assignee: Verizon Patent and Licensing, Inc., Basking Ridge, NJ (US)

(21) Appl. No.: 12/827,127

(22) Filed: Jun. 30, 2010

(51) Int. Cl. G06Q 10/00; G06F 3/048; G09G 5/22

(52) U.S. Cl. 705/7.29; 345/440.1; 715/771

(57) ABSTRACT

A system receives, from a user device, a request for a joint business and services tracking tool. The system obtains business data associated with the customer and retrieve service management data associated with the customer. The system generates, in response to the request, a user interface, where the user interface includes a time-based graphical representation of the business data, a time-based graphical representation of the service management data, and a linking object to link the business data and the service management data over a particular time period. The system further provides a service management dashboard, associated with the linking object, to present the customer business data and the service management data within the particular time period.

### BACKGROUND

Companies that provide services to customers frequently provide their customers with automated techniques for viewing or managing accounts relating to these services. A service company may, for instance, manage a web site designed to allow its customers to login to the web site and view and/or modify information specific to account(s) maintained with the company.

Customer performance indicators for business functions are typically tracked by the customer. Performance indicators for networks used to support the customer business functions are typically tracked by a network service provider and may not relate specifically to a particular customer. In instances where the combination of customer performance indicators and network performance indicators has been desirable, assembling this combination has generally been inefficient and subject to delay.

### BRIEF DESCRIPTION OF THE DRAWINGS

FIG. 1 is an example diagram illustrating a concept described herein;

FIG. 2 is an example network in which systems and/or methods described herein may be implemented;

FIG. 3 is a diagram of example components of a service management platform of FIG. 2;

FIG. 4 is a diagram of example components of one of the devices depicted in FIG. 2 and/or FIG. 3;

FIG. 5 is a diagram of example functional modules of an application server of FIG. 3;

FIGS. 6A-6C are diagrams of example user interfaces for a joint business and services tracking page; and

FIG. 7 is a flow chart of an example process for integrating data management for network service providers and customers according to an implementation described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may include systems and/or methods that may provide interactive management services that combine customer business indicators with service performance indicators. In one implementation, systems and/or methods described herein may receive, from a user device, a request for a joint business and services tracking tool. The systems and/or methods may obtain business data from the customer and service management data associated with the customer. Service management data (also referred to herein as “service provider data”) may include, for example, network services data (e.g., from routers, hubs, load balancers, etc.), security data (e.g., from firewalls, intrusion detection devices, traffic logs, fraud analytics, etc.), and/or application/hosting data (e.g., for services, operations support systems (OSS), databases, web servers, applications, etc.) The systems and/or methods may generate, in response to the request, a user interface, where the user interface includes a time-based graphical representation of the business data, a time-based graphical representation of the service management data, and a linking object to link the business data and the service management data over a particular time period. The systems and/or methods may further provide a service management dashboard, associated with the linking object, to present the customer business data and the service management data within the particular time period.

As used herein, the terms “user” and “customer” are intended to be broadly interpreted to include a user device and/or a user application, or a user of a user device and/or a user application. A user application may include any operating system software and/or application software that make use of features and may be executed by a user device.

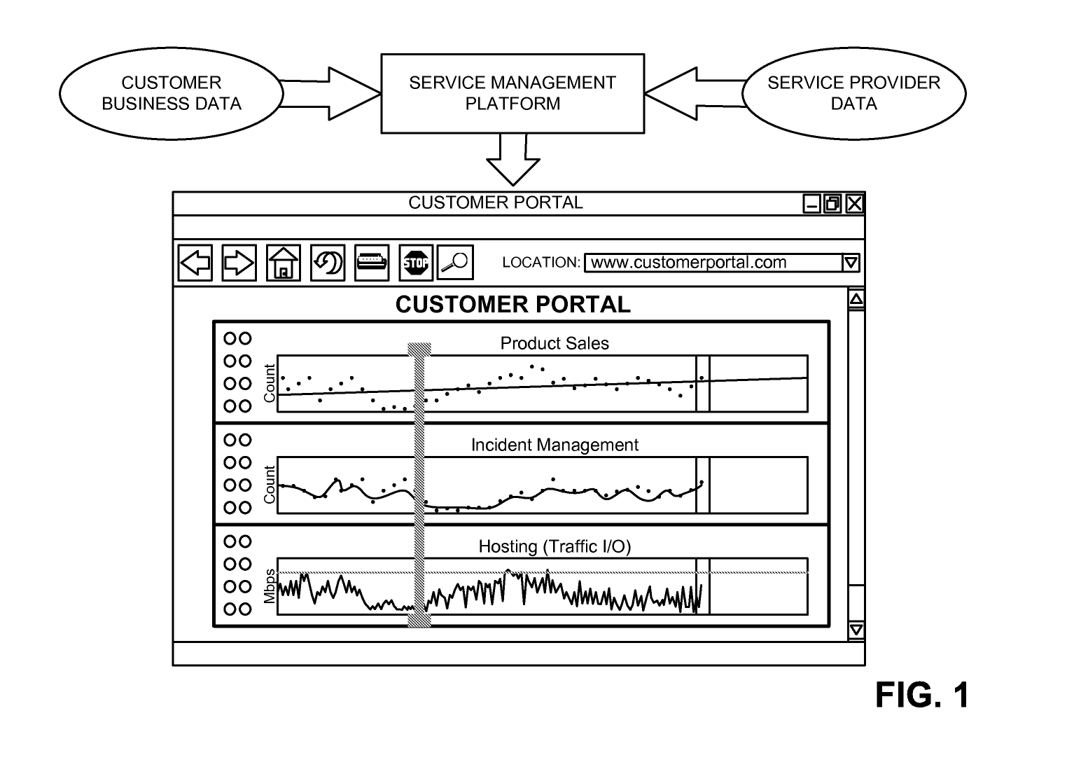

FIG. 1 is an example diagram illustrating a concept described herein. A service management platform may receive customer business data and service provider data (e.g., network services data, security data, and/or application/hosting data). Customer business data may track business performance over time. Customer business data may include, for example, key performance indicators for a customer's business, such as sales data, service inquiries, technical support data, etc. Service provider data may track resources used to support customer business objectives. Service provider data may include, for example, incident reports (e.g., tickets, alarms, maintenance events, etc.), bandwidth usage, and/or application services associated with network resources allocated to the customer.

The service management platform may correlate the customer business data and the service provider data and present the data to the customer through a user interface in a customer services portal. The customer services portal may include a joint business and services tracking function that provides a visually driven and interactive data management tool. For example, the customer services portal may allow for interactive customer input for key event data versus time. Also, the concurrent presentation of customer business data and service provider data in the customer services portal may allow for data extraction of multiple data types for a particular time period (referred to herein as “banding”). Furthermore, the customer services portal may provide predictive information and threshold indicators for alerts and proactive management of services.

In one implementation, customer business data from a customer-managed source (e.g., a database) may be integrated through a secure network connection to the service management platform, where the service provider data and the customer business data can be integrated. In another implementation, where customer business data is considered private or restricted, the customer business data may be collected and managed by a customer and integrated, by the customer, into the customer services portal.

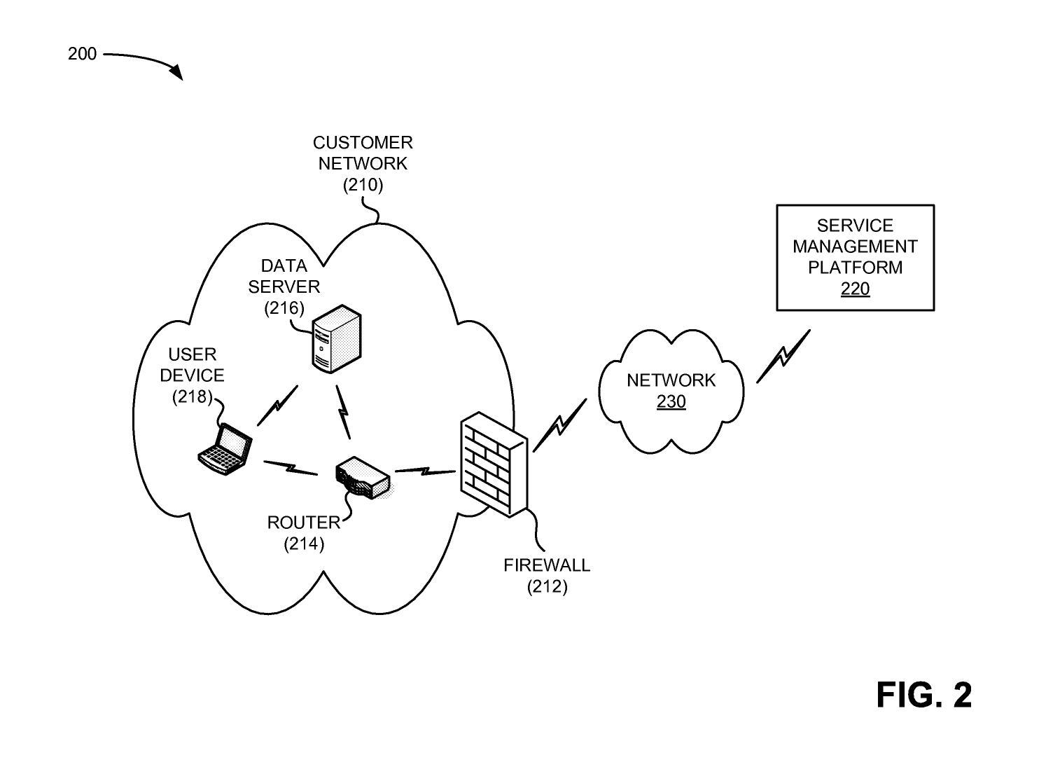

FIG. 2 is an example network 200 in which systems and/or methods described herein may be implemented. As illustrated, network 200 may include a customer network 210 that may connect to a service management platform 220 via a network 230. Components of network 200 may interconnect via wired and/or wireless connections. One customer network 210, service management platform 220, and network 230 have been illustrated in FIG. 2 for simplicity. In practice, there may be more customer networks 210, service management platforms 220, and/or networks 230.

Customer network 210 may include a local area network (LAN), a metropolitan area network (MAN), a wide area network (WAN), a private network, an intranet, and/or another type of network that may be associated with a customer's business. As illustrated, customer network 210 may include the following example components: a firewall 212, a router 214, a data server 216, and user device 218.

Firewall 212 may include one or more devices that control the flow of traffic between different networks and protect customer network 210 from undesired traffic that may be generated by hackers, viruses, spyware, spam, and denial of service attacks. Firewall 212 may further protect the customer's business data and assets from traffic originating on network 230. Firewall 212 may permit or deny traffic based upon a set of rules.

Router 214 may include one or more devices that receive traffic from a component in customer network 210 and route the traffic toward the appropriate destination(s). Additionally, router 214 may receive traffic from a component outside customer network 210 (e.g., via firewall 212) and route the traffic toward the appropriate component in customer network 210.

Data server 216 may include one or more server devices, or other types of computation or communication devices, that gather, process, search, and/or provide information in a manner described herein. Data server 216 may be associated with a database or other storage device. In an example implementation, data server 216 may store customer data repositories, information associated with one or more customer products and/or services, and/or any other information associated with customer business functions. In one implementation, data server 216 may send stored customer data to service management platform 220 using, for example, a secure network connection over network 230. In another implementation, data server 216 may format customer data and apply the data locally to other data layers of a joint business and services tracking page supplied by service management platform 220.

User device 218 may include one or more computing devices, or other types of computation or communication devices, that gather, process, search, and/or provide information in a manner described herein. In an example implementation, user device 150 may include a desktop computer, laptop computer, a personal digital assistant (PDA), and/or other types of devices that may be part of a customer's business and may be accessed through customer network 210. User device 218 may enable a user to create, review, access, prioritize, etc. information from a joint business and services tracking page in a manner described herein.

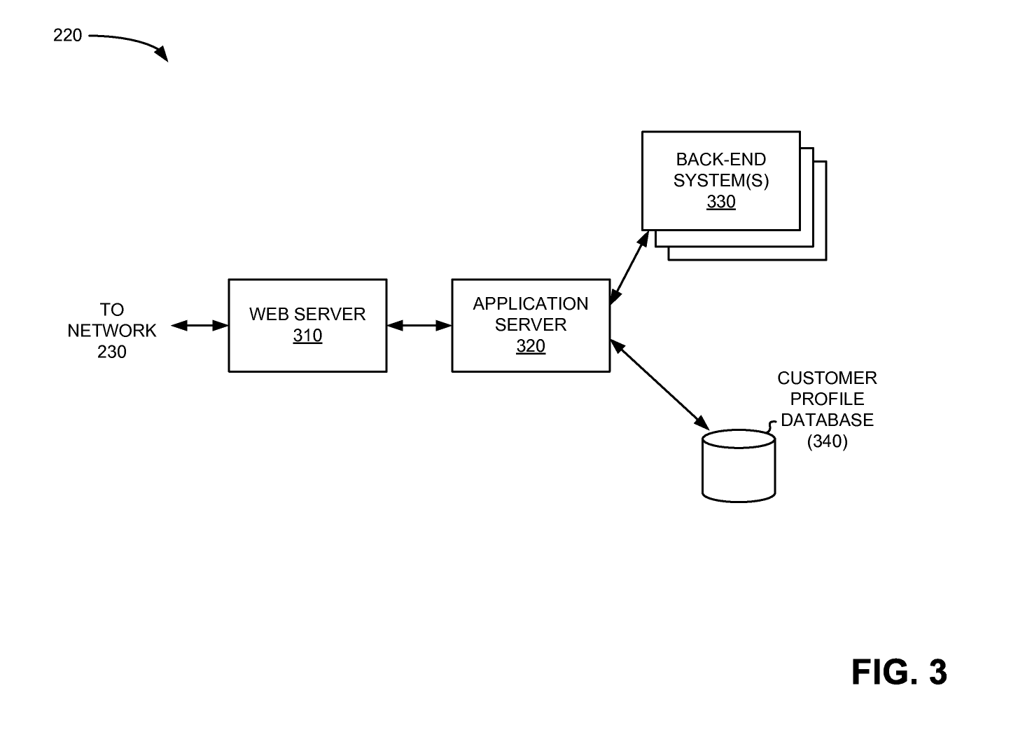

Service management platform 220 may include one or more devices that retrieve customer network data and receive customer business information from customer network 210. Service management platform 220 may associate network performance data with particular customer business data to provide a joint business and services tracking function. In addition, service management platform 220 may provide a portal via which the customer may review the joint business and services tracking function. Service management platform 220 is described further below in connection with, for example, FIG. 3.

Network 230 may include one or more networks of any type, including a Public Land Mobile Network (PLMN), a Public Switched Telephone Network (PSTN), a LAN, a MAN, a WAN, a private network, the Internet, an intranet, and/or another type of network.

Although FIG. 2 shows example components (e.g., devices) of network 200, in other implementations, network 200 may contain fewer components, different components, differently arranged components, or additional components than depicted in FIG. 2. Alternatively, or additionally, one or more components of network 200 may perform one or more other tasks described as being performed by one or more other components of network 200.

FIG. 3 is a diagram of example components of service management platform 220. As shown in FIG. 3, service management platform 220 may include a web server 310, an application server 320, back-end systems 330, and a customer profile database 340.

Web server 310 may include one or more server devices, or other types of computation or communication devices, that gather, process, search, and/or provide information in a manner described herein. In one implementation, web server 310 may supply web services for use by user device 218. Web server 310 may dynamically generate web pages for each user accessing web server 310. In particular, consistent with aspects described herein, web server 310 may transmit data (e.g., customer business data and/or service provider data), hypertext markup language (HTML) documents, and/or scripts (e.g., JavaScript, VBScript, or other computer code) to user device 218. The scripts may include, for example, script for generating real time data graphs, linking objects, dashboards, and other interactive objects.

Application server 320 may include one or more server devices, or other types of computation or communication devices, that gather, process, search, and/or provide information in a manner described herein. In one implementation, application server 320 may act as a middle layer between web server 310 and back-end systems 330, and between back-end systems 330 and customer profile database 340. Application server 320 may generally operate to, in response to a request from web server 310, retrieve service customer business data and/or service provider data from back-end systems 330, query customer profile database 340 to determine valid actions for a user (e.g., a user of user device 218), and return this information to web server 310. Application server 320 may be an optional component. That is, in some implementations, application server 320 may not be used and web server 310, for example, may additionally perform the functions of application server 320.

Back-end systems 330 may include one or more systems that provide or administer the services that are to be managed via service management platform 220. For example, in the context of the telecommunications industry, back-end systems 330 may include router devices, quality monitoring systems, billing systems, order placement systems, repair systems, provisioning systems, engineering systems, or devices for managing such systems. Some of back-end systems 330 may be legacy systems that perform functions similar to newer, non-legacy, versions of the back-end systems.

Customer profile database 340 may include one or more tables to store data that represents available data services and/or access for a given customer account. Customer profile database 340 may be implemented as, for example, a relational or non-relational database capable of storing and accessing data. Customer profile database 340 may be implemented on a single computing device or distributed across many computing devices and/or storage devices. In some alternate implementations, customer profile database 340 may be implemented as a simple “flat” file or other similar structure.

Although FIG. 3 shows example components (e.g., devices) of service management platform 220, in other implementations, service management platform 220 may contain fewer components, different components, differently arranged components, or additional components than depicted in FIG. 3. Alternatively, or additionally, one or more components of service management platform 220 may perform one or more other tasks described as being performed by one or more other components of service management platform 220.

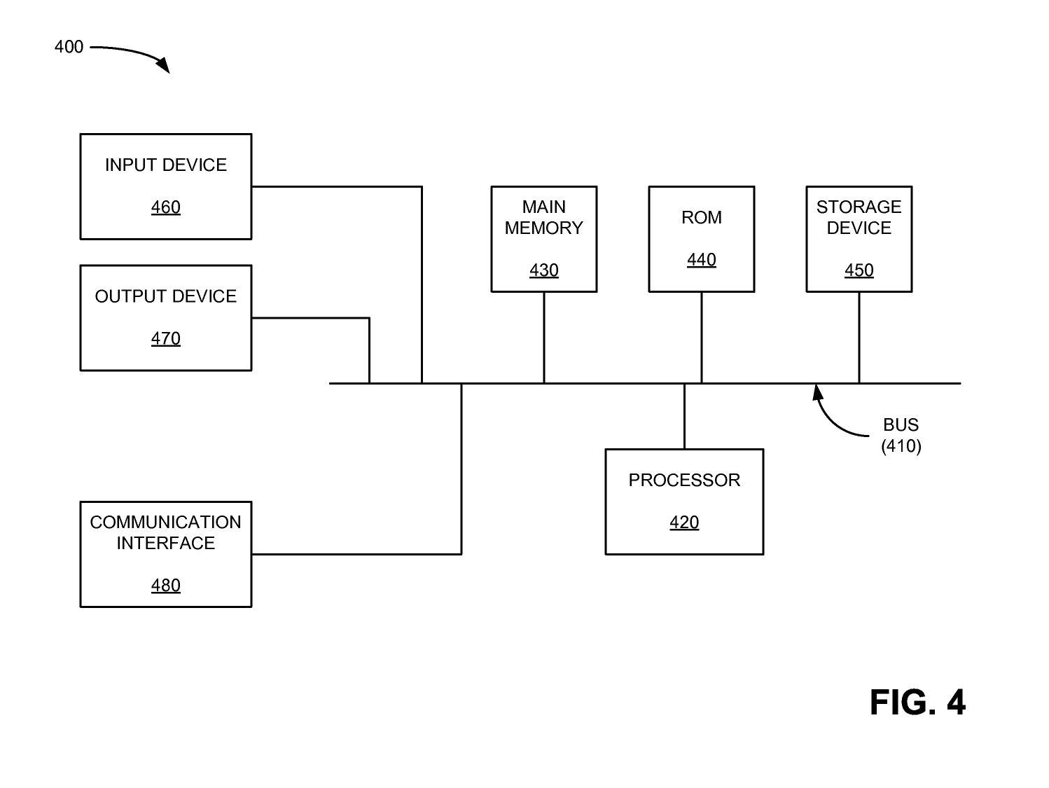

FIG. 4 is an example diagram of a device 400 that may correspond to one or more of data server 216, user device 218, web server 310, application server 320, and/or back-end systems 330. As illustrated, device 400 may include a bus 410, a processor 420, a main memory 430, a read-only memory (ROM) 440, a storage device 450, an input device 460, an output device 470, and/or a communication interface 480. Bus 410 may include a path that permits communication among the components of device 400.

Processor 420 may include one or more processors, microprocessors, or other types of processing units that may interpret and execute instructions. Main memory 430 may include a random access memory (RAM) or another type of dynamic storage device that may store information and instructions for execution by processor 420. ROM 440 may include a ROM device or another type of static storage device that may store static information and/or instructions for use by processor 420. Storage device 450 may include a magnetic and/or optical recording medium and its corresponding drive for storing information and/or instructions. In one implementation, storage device 450 may include one or more databases for storing, for example, customer business data and/or service provider data.

Input device 460 may include a mechanism that permits an operator to input information to device 400, such as a keyboard, a mouse, a pen, a microphone, voice recognition and/or biometric mechanisms, etc. Output device 470 may include a mechanism that outputs information to the operator, including a display, a printer, a speaker, etc. Communication interface 480 may include any transceiver-like mechanism that enables device 400 to communicate with other devices and/or systems. For example, communication interface 480 may include mechanisms for communicating with another device or system via a network.

As described herein, device 400 may perform certain operations in response to processor 420 executing software instructions contained in a computer-readable medium, such as main memory 430. A computer-readable medium may be defined as a physical or logical memory device. A logical memory device may include memory space within a single physical memory device or spread across multiple physical memory devices. The software instructions may be read into main memory 430 from another computer-readable medium, such as storage device 450, or from another device via communication interface 480. The software instructions contained in main memory 430 may cause processor 420 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows example components of device 400, in other implementations, device 400 may contain fewer components, different components, differently arranged components, or additional components than depicted in FIG. 4. Alternatively, or additionally, one or more components of device 400 may perform one or more other tasks described as being performed by one or more other components of device 400.

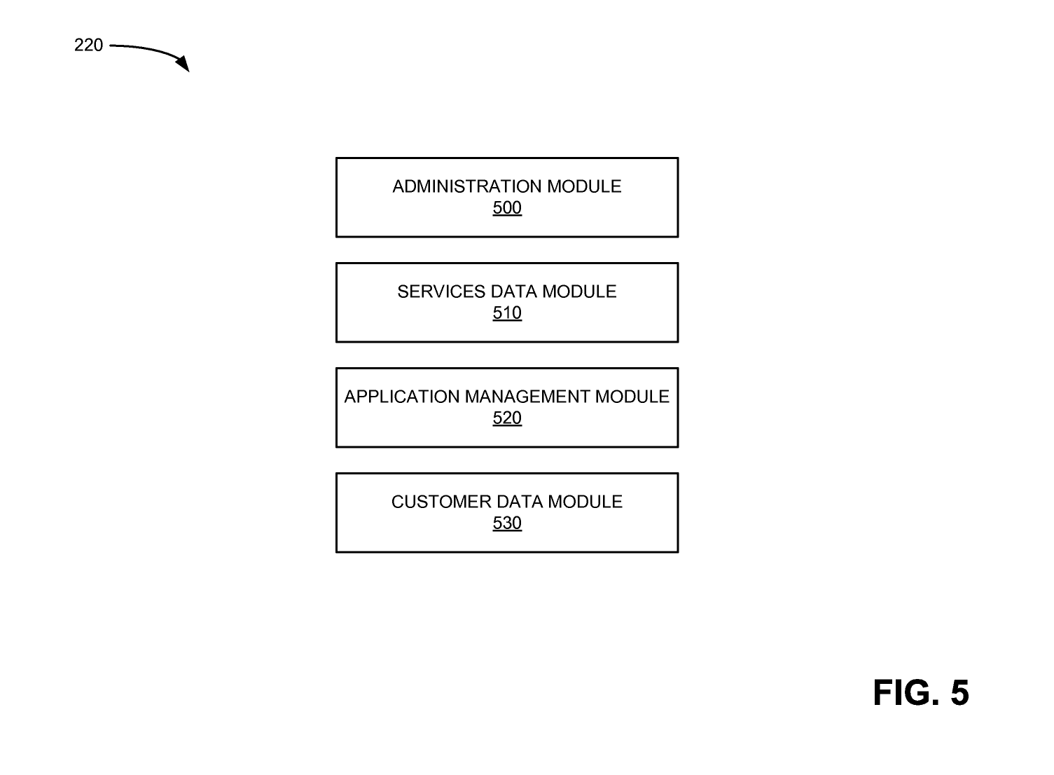

FIG. 5 is a diagram of example functional modules that may be associated with one or more components of service management platform 220. For example, modules of FIG. 5 may be associated with application server 320 (FIG. 3). In another implementation, the modules of FIG. 5 may be associated with one or more of web server 310, application server 320, back-end systems 330, and/or customer profile database 340. As illustrated in FIG. 5, the example modules may include an administration module 500, a services data module 510, an application management module 520, and a customer data module 530.

Administration module 500 may include hardware or a combination of hardware and software to provide data and/or self service tools for a customer and a network associated with the customer (e.g., a user of user device 218). Administration module 500 may manage access privileges (e.g., via a customer portal) to provide data to a customer that includes access only to information and/or actions that are applicable to the specific customer account. For example, in one implementation, administration module 500 may provide different access privileges to service management platform 220 based on accounts assigned within a customer entity (e.g., different divisions or sections of a corporation) or based on accounts assigned to different customers. For example, a customer may access (e.g., via network 230) service management platform 220 and provide an account name and/or password that may be verified by administration module 500 before granting the customer access to other modules of service management platform 220. In one implementation, administration module 500 may also provide service provisioning, a service catalog, account information, the customer's roles and entitlements, an account communicator, and/or online collaboration services for the customer's network.

Services data module 510 may include hardware or a combination of hardware and software to track service provider data for a network and/or resources associated with a customer. For example, in one implementation, services data module 510 may provide data for network services, security, and/or applications/hosting associated with a particular customer (e.g., a customer having account privileges with administration module 500). Examples of data provided by services data module 510 include network availability status, performance reporting, metric reporting, a network topology map, inventory and/or auto discovery services, fault and trouble management, security and/or threat identification services, and/or customer platform access services for the customer's network. Services data module 510 may include incident data such as tickets, alarms, maintenance events, and other data that relates to network infrastructure. In a further implementation, services data module 510 may track bandwidth use data correlated to particular customer products and/or activities. Services data module 510 may also incorporate threshold alerts for network activity to identify predictive trends. In one implementation, data for services data module 510 may be updated in real time or near-real time.

Application management module 520 may include hardware or a combination of hardware and software to provide business services data tools for a network associated with a customer (e.g., a user of user device 218). For example, upon a customer's authorized access (e.g., via administration module 500) to service management platform 220, application management module 520 may receive a request from the customer to access a joint business and services tracking function. In response to the request, application management module 520 may retrieve information (e.g., historical and/or real-time data) from services data module 510 and customer data module 530 and may generate a graphical representation of the data. In one implementation, the format for data from services data module 510 and customer data module 530 may be applied to one or more templates to provide a graphical user interface. The templates may be modified and/or configured by the customer. In one implementation, application management module 520 may permit the customer to perform general business outcome testing, business impact analysis, and/or true cost of service metrics for the customer's network. In another example, application management module 520 may provide enterprise application interfaces (e.g., point-of-sale networks and kiosks), web hosting, and/or security management services for the customer's network.

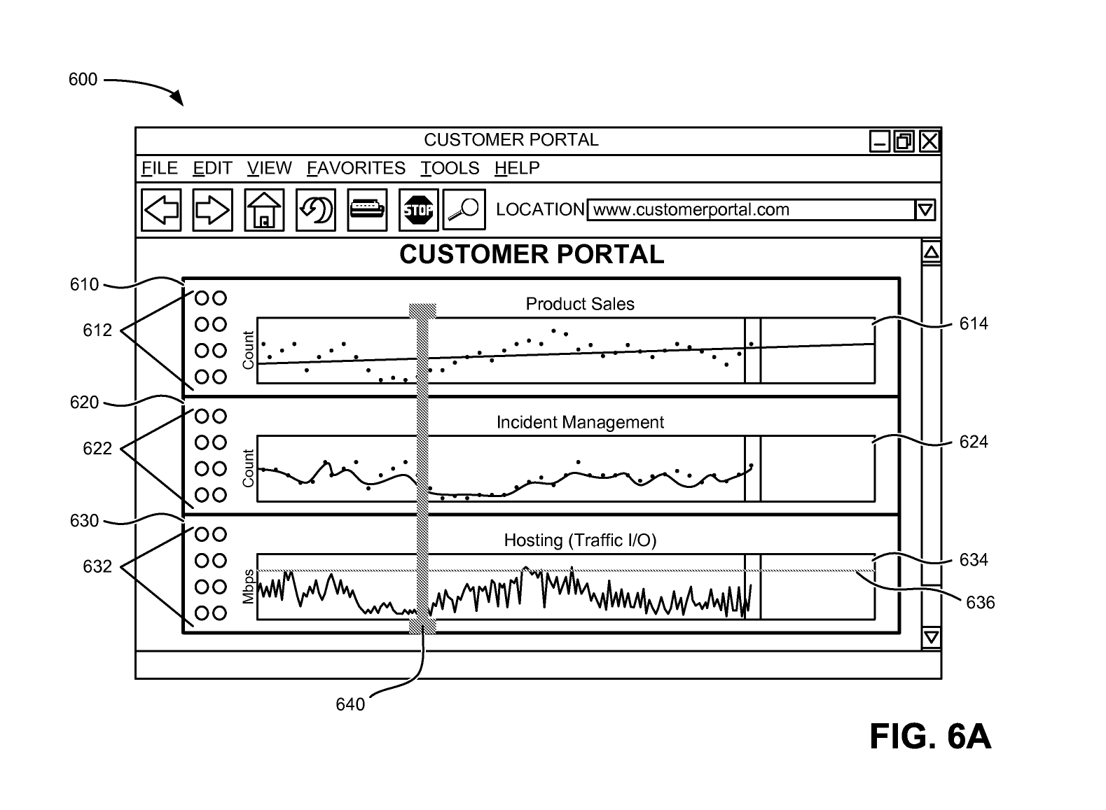

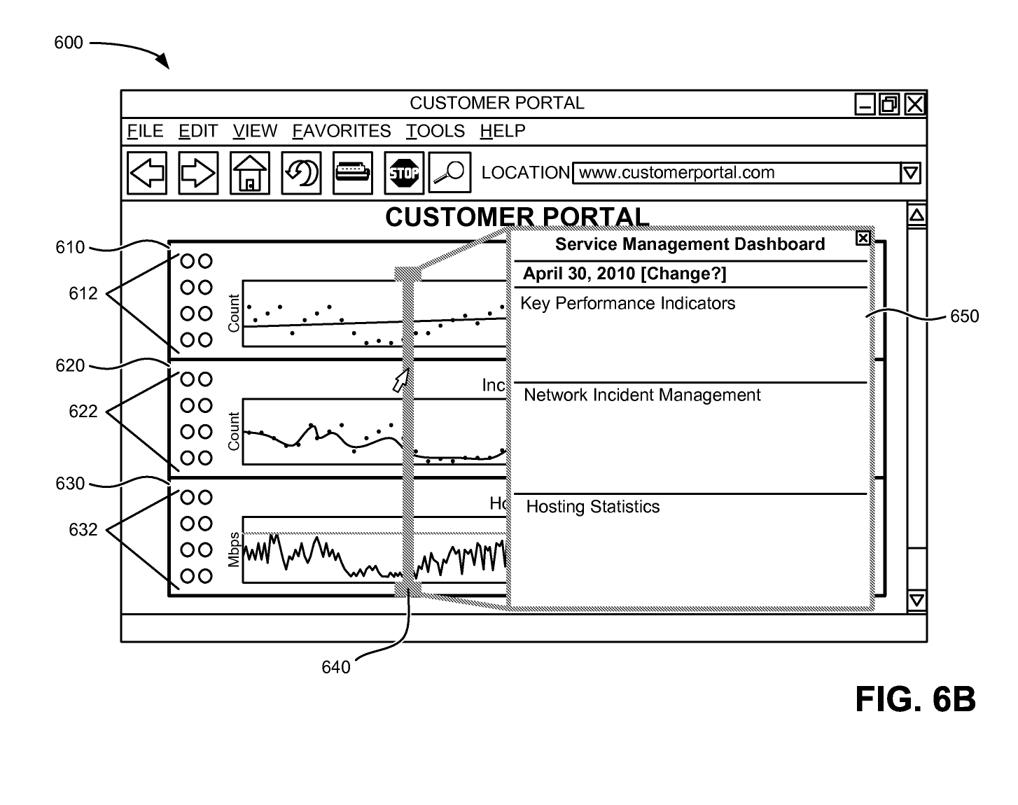

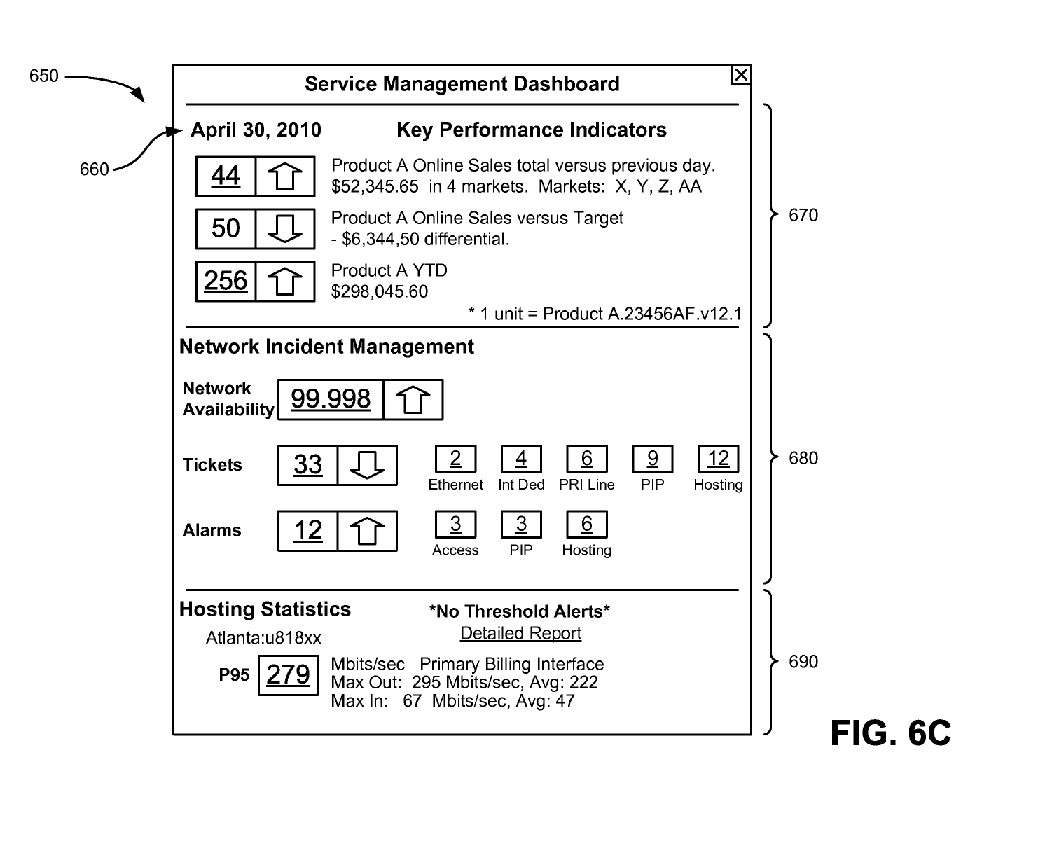

In one implementation, application management module 520 may provide banding of data from services data module 510 and customer data module 530 to allow, for example, real-time network traffic monitoring and threshold alerts versus a customer business function. Banding may be used to link data from multiple sources (e.g., from services data module 510 and customer data module 530) over a discrete time period. A time period for banding may, for example, be adjusted by a user to cover a smaller (e.g., minutes, hours, etc.) or larger (e.g., days, weeks, etc.) time period. In one implementation, application management module 520 may supply a banding indicator over a graphical representation of multiple data sets to allow a user to visually associate concurrent data. Banding may also be used to provide detailed information for multiple data sets and for the same banded time period. In one implementation, data for banded time periods may be stored to produce, for example, trending charts over longer periods to, for example, analyze business results. Banding is described further in connection with the user interface of FIG. 6.

Customer data module 530 may include hardware or a combination of hardware and software to provide customer data (e.g., customer-specific data that may not otherwise be available and/or accessible to the service provider). Customer data may include, for example, key performance indicators for a customer's business, such as sales data, service inquiries, technical support performance data, etc. In one implementation, customer data may be stored within a customer managed database (e.g., customer profile database 340) from where the customer data may be formatted for use in service management platform 220. Additionally, or alternatively, some or all of the data associated with customer data module 530 may be stored within customer network 210. That is, a customer may keep some data (e.g., private data) resident within customer network 210 and/or supply data to the service provider. For example, service management platform 220 may supply data format criteria to the customer, and the customer may manage customer data at its own site (e.g., within customer network 210) to conform to the format compatible with service management platform 220. The customer data may be supplied as a separate data layer onto network data (e.g., from services data module 510) when accessed via a customer portal. In one implementation, data for customer data module 530 may be updated in real time or near-real time.

Although FIG. 5 shows example functional modules that may be associated with service management platform 220, in other implementations, service management platform 220 may store fewer functional modules, different functional modules, or additional functional modules than depicted in FIG. 5. Alternatively, or additionally, one or more functional modules of service management platform 220 may perform one or more other tasks described as being performed by one or more other functional modules of service management platform 220.

FIG. 6A-6C are diagrams of an example user interface 600 for a joint business and services tracking page. In one implementation, user interface 600 may be provided by web server 310 to user device 218. As illustrated in FIG. 6A-6C, the joint business and services tracking page of user interface 600 may depict a variety of information about one or more networks and corresponding business data associated with a customer (e.g., a customer who accessed web server 310 via user device 218). Referring to FIG. 6A, the joint business and services tracking page may provide a customer business section 610, an incident management section 620, a hosting section 630, and/or a banding indicator 640.

Customer business section 610 may include a graphical representation of customer generated data that defines, for example, customer business services versus time. In one implementation, customer business section 610 may include data from customer data module 530. In another implementation, data for customer business section 610 may include data compiled by another entity (e.g., a network provider) and supplemented by the customer. Customer business section 610 may include controls 612 to toggle/filter the presentation of particular data fields within a time-based graphical representation 614. Data fields may include, for example, raw data, normalized data, target data, etc. associated with a customer's business and/or particular products/services of a customer's business.

Incident management section 620 may include a graphical representation of network-related incident data for the particular customer versus time. In one implementation, network-related incident data may include data from services data module 510, such as tickets, alarms, maintenance events, and other data that relates to network infrastructure. Incident management section 620 may include controls 622 to toggle/filter the presentation of particular data fields within a time-based graphical representation 624. Time-based graphical representation 624 may be synchronized with time-based graphical representation 614 and time-based graphical representation 634.

Hosting section 630 may include a graphical representation of application hosting services data for the particular customer versus time. In one implementation, application hosting services data may include data from services data module 510, such as bandwidth usage. Hosting section 630 may include controls 632 to toggle/filter the presentation of particular data fields within a time-based graphical representation 634. For example, a user of user interface 600 may select controls 632 to view particular applications that correlate to customer inventory display in customer business section 610. Hosting section 630 may also include a threshold indicator 636. Threshold indicator 636 may provide a visual indication of when bandwidth usage approaches an alert level, such as a particular percentage of a maximum level. Threshold indicator 636 may provide a benchmark for alerts and proactive management of services. For example, users may be alerted to bandwidth levels being hit as warnings for capacity management. In one implementation, threshold indicator 636 may indicate a bandwidth usage level at which an auto-alert feature would be invoked. Threshold indicator 636 may be adjusted by a user of user interface 600.

Banding indicator 640 may include a graphical representation of a discrete time period over multiple sections (e.g., customer business section 610, incident management section 620, and/or hosting section 630). Banding indicator 640 may, for example, be adjusted by a user to cover a smaller (e.g., narrower) or larger (e.g., wider) time period. For example, banding indicator 640 may be adjusted to span particular hours, portions of a day, days, weeks, etc. Banding indicator 640 may allow a user to select a period of time to collect statistics, total throughput, highs/lows, etc. in the selected period for data in multiple sections. In one implementation, data for banding increments may be stored to produce, for example, trending charts over longer periods to analyze business results.

Referring to FIG. 6B, in one implementation, banding indicator 640 may be selected by a user (e.g., using input device 460) to display a service management dashboard 650 for the particular time period associated with banding indicator 640. In one implementation, as shown in FIG. 6B, service management dashboard 650 may be superimposed over all or a portion of other information (e.g., customer business section 610, incident management section 620, and hosting section 630) in user interface 600. Service management dashboard 650 may include multiple sections that correspond to sections (e.g., customer business section 610, incident management section 620, and hosting section 630) and/or filters (e.g., from controls 612, controls 622, and/or controls 632) active in the underlying portion of user interface 600. In other implementations, service management dashboard 650 may include an integration of data (e.g., data for the particular time period associated with banding indicator 640) in, for example, a format defined by a user.

FIG. 6C provides a larger view of service management dashboard 650. As shown in FIG. 6C, service management dashboard 650 may include a time period 660, detailed information 670 (e.g., associated with customer business section 610), detailed information 680 (e.g., associated with incident management section 620), and detailed information 690 (e.g., associated with hosting section 630). Time period 660 may correspond to the time span (e.g., width) of banding indicator 640. Time period 660 may be represented as a single time frame (e.g., a particular day, as shown in FIG. 6C) or as any time span defined by a particular starting point and stopping point.

Detailed information 670 may provide an enhanced information display for data associated with the banded time period of customer business section 610. For example, detailed information 670 may provide key performance indicators in the form of actual numbers (e.g., for time period 660) associated with time-based graphical representation 614 of customer business section 610. In one implementation, detailed information 670 may include trending indicators (e.g., arrows) and/or extrapolated dollar values from raw data. In one implementation, the format for detailed information 670 may be configured by the user and/or selected from one or more format templates. In one implementation, some detailed information 670 may include hyperlinks to additional details.

Detailed information 680 may provide an enhanced information display for data associated with the banded time period of incident management section 620. For example, detailed information 680 may provide network incident management data in the form of actual numbers (e.g., for time period 660) associated with the time-based graphical representation 624 of incident management section 620. In one implementation, detailed information 680 may include trending indicators (e.g., arrows) and/or breakouts of more generalized information. For example, as shown in FIG. 6C, detailed information 680 may include a overall number for “tickets” (e.g., 33) received during time period 660 and a breakout of categories within the overall number of tickets (e.g., “2—Ethernet,” “4—Int Ded,” “6—PRI Line,” etc.). In one implementation, some detailed information 680 may include hyperlinks to additional details.

Detailed information 690 (e.g., associated with hosting section 630) may provide an enhanced information display for data associated with the banded time period of hosting section 630. For example, detailed information 690 may provide hosting statistics in the form of actual numbers (e.g., for time period 660) associated with the time-based graphical representation 634 of hosting section 630. In one implementation, detailed information 690 may include alert indicators, averages, and/or high and low marks for time period 660. In one implementation, some detailed information 690 may include hyperlinks to additional details.

Although FIGS. 6A-6C show example sections of user interface 600 for a joint business and services tracking page, in other implementations, user interface 600 may include fewer sections, different sections, differently arranged sections, or additional sections than depicted in FIGS. 6A-6C. Furthermore, the presentation of data may vary within each section of user interface 600.

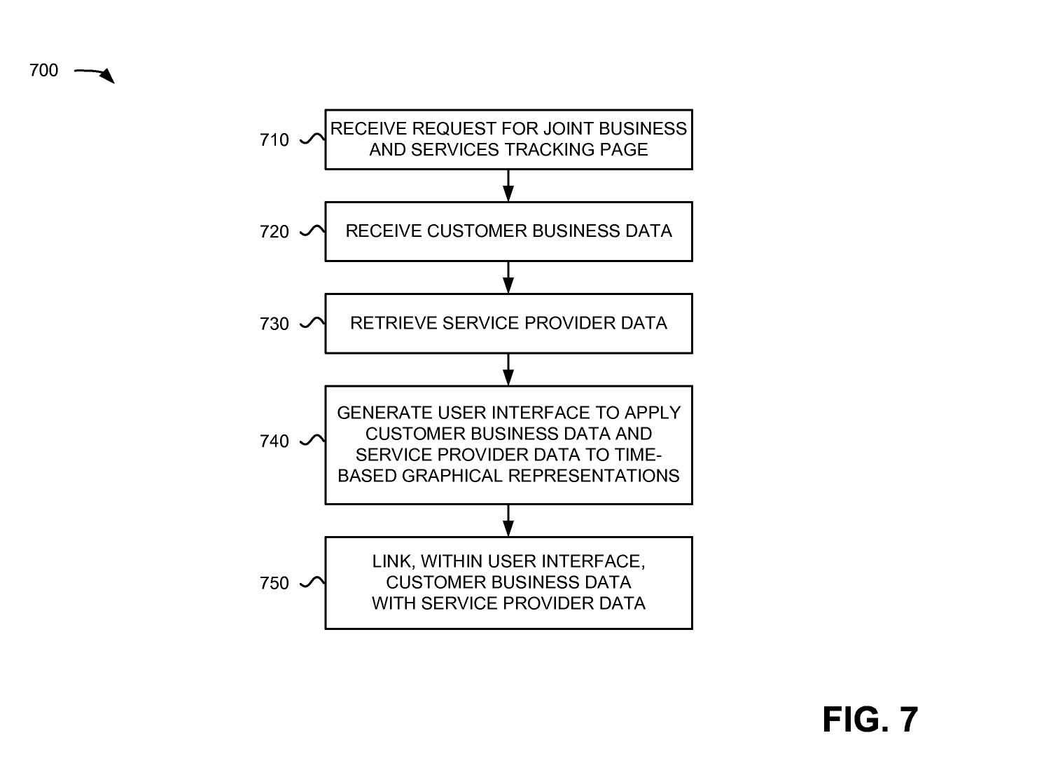

FIG. 7 is a flow chart of an example process for integrating data management for network service providers and customers according to implementations described herein. In one implementation, process 700 may be performed by application server 320. In another implementation, some or all of process 700 may be performed by another device or group of devices, including or excluding application server 320.

As shown in FIG. 7, process 700 may include receiving a request for a joint business and services tracking page (block 710), receiving customer business data (block 720), and retrieving service provider data (block 730). For example, in implementations described above in connection with FIG. 5, a customer may access (via network 230) service management platform 220 and provide an account name and/or password that may be verified by administration module 500 before granting the customer access to other modules of service management platform 220. Upon a customer's authorized access, application management module 520 may receive a request from the customer to access a joint business and services tracking function. In response to the request, application management module 520 may retrieve information (e.g., historical and/or real-time data) from services data module 510 and customer data module 530.

As further shown in FIG. 7, process 700 may include generating a user interface to apply the customer business data and the service provider data to a time-based graphical representation (block 740), and linking, within the user interface, the customer business data with the service provider data (block 750). For example, in implementations described above in connection with FIG. 5, application management module 520 may generate a graphical representation of the data from services data module 510 and customer data module 530. In one implementation, the format for data from services data module 510 and customer data module 530 may be applied to one or more templates to provide a graphical user interface. Application management module 520 may provide banding of data from services data module 510 and customer data module 530 to allow, for example, real-time network traffic monitoring and threshold alerts versus a customer business function. Banding may be used to link data from multiple sources (e.g., from services data module 510 and customer data module 530) over a discrete time period. A time period for banding may, for example, be adjusted by a user to cover a smaller (e.g., minutes, hours, etc.) or larger (e.g., days, weeks, etc.) time period. In one implementation, application management module 520 may supply a banding indicator over a graphical representation of multiple data sets to allow a user to visually associate concurrent data.

Implementations described herein may include systems and/or methods that may receive, from a user device, a request for a joint business and services tracking tool. The systems and/or methods may obtain business data associated with the customer and may retrieve network services data associated with the customer. The systems and/or methods may generate, in response to the request, a user interface, where the user interface includes a time-based graphical representation of the business data, a time-based graphical representation of the network services data, and a linking object to link the business data and the network services data over a particular time period. The systems and/or methods may further provide a service management dashboard, associated with the linking object, to present the customer business data and the network services data within the particular time period.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks has been described with regard to FIG. 7, the order of the blocks may be modified in other implementations. Further, non-dependent blocks may be performed in parallel.

It will be apparent that aspects, as described herein, may be implemented in many different forms of software, firmware, and hardware in the implementations illustrated in the figures. The actual software code or specialized control hardware used to implement embodiments described herein is not limiting of the invention. Thus, the operation and behavior of the embodiments were described without reference to the specific software code—it being understood that software and control hardware may be designed to implement the embodiments based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method implemented by a computing device associated with a service provider network, the method comprising:
receiving, by the computing device and from a customer, a request for a joint business and services tracking tool;
obtaining, by the computing device and based on the request, business data associated with the customer;
retrieving, by the computing device and based on the request, service management data associated with the customer; and
generating, by the computing device and in response to the request, a user interface where the user interface includes:
a time-based graphical representation of the business data,
a time-based graphical representation of the service management data, and
a linking object to link the business data and the service management data over a particular time period.

2. The method of claim 1, where the time-based graphical representation of the business data and the time-based graphical representation of the service management data are updated in real time.

3. The method of claim 1, where the service management data includes one or more of:
network services data,
security data, or
hosting data.

4. The method of claim 1, where the business data includes one or more performance indicators for a business associated with the customer.

5. The method of claim 1, where the linking object comprises:
a banding indicator for the time-based graphical representation of the business data and the time-based graphical representation of the service management data, where the banding indicator identifies the particular time period associated with the business data and the service management data.

6. The method of claim 5, where the particular time period associated with the banding indicator is defined by the customer.

7. The method of claim 1, where the user interface further includes:
a service management dashboard, associated with the linking object, to present the business data and the service management data within the particular time period.

8. The method of claim 7, where the service management dashboard comprises:
elements associated with the time-based graphical representation of the business data,
elements associated with the time-based graphical representation of the service management data,
trending indicators associated with the time-based graphical representation of the business data,
trending indicators associated with the time-based graphical representation of the service management data.

9. The method of claim 1, where the time-based graphical representation of the business data and the time-based graphical representation of the service management data each include controls to filter presentation of particular data fields within the time-based graphical representation of the business data or the time-based graphical representation of the service management data.

10. A method implemented by a service management platform within a service provider network, the method comprising:
receiving, by the service management platform and from a user device, a request for access to a joint business and services tracking tool;
providing, by the service management platform and to the user device, formatting criteria to conform customer business data to a format compatible with the service management platform;
retrieving, by the service management platform and based on the request, service management data associated with the customer;
generating, by the service management platform and in response to the request, a user interface where the user interface includes:
a template for a time-based graphical representation of the customer business data, where the template is to receive the customer business data in the format compatible with the service management platform,
a time-based graphical representation of the service management data, and
a linking object to link the customer business data and the service management data over a particular time period; and
sending, by the service management platform and to the user device, the user interface.

11. The method of claim 10, where the time-based graphical representation of the service management data is updated in real time.

12. The method of claim 10, where the linking object comprises:
a banding indicator for the template for the time-based graphical representation of the customer business data and the time-based graphical representation of the service management data, where the banding indicator identifies the particular time period associated with the customer business data and the service management data.

13. The method of claim 10, where the user interface further includes:
a service management dashboard, associated with the linking object, to present the customer business data and the service management data within the particular time period.

14. A system, comprising:
a memory to store a plurality of instructions; and
a processor to execute instructions in the memory to:
receive, from a user device, a request for a joint business and services tracking tool,
obtain business data associated with the customer,
retrieve service management data associated with the customer, and
generate, in response to the request, a user interface, where the user interface includes:
a time-based graphical representation of the business data,
a time-based graphical representation of the service management data, and
a linking object to link the business data and the service management data over a particular time period.

15. The system of claim 14, where the linking object comprises:
a banding indicator for the time-based graphical representation of the business data and the time-based graphical representation of the service management, where the banding indicator identifies the particular time period associated with the business data and the service management data.

16. The system of claim 14, where the user interface further includes:
a service management dashboard, associated with the linking object, to present the customer business data and the service management data within the particular time period.

17. The system of claim 14, where the time-based graphical representation of the business data and the time-based graphical representation of the service management data each include data filter controls, and where the processor is further to execute instructions in the memory to:
present, based on a user selection of the data filter controls, particular data fields within the time-based graphical representation of the business data or the time-based graphical representation of the service management data.

18. The system of claim 14, where, when obtaining business data associated with the customer, the processor is further to execute instructions in the memory to:
receive, from a device within a customer network, the business data, or
receive, from a device within a service provider network, the business data, where the service provider network is different than the customer network.

19. A computer-readable medium containing instructions executable by a processor, the computer-readable medium comprising:
one or more instructions for receiving, from a user device, a request for a joint business and services tracking tool,
one or more instructions for obtaining business data associated with the customer,
one or more instructions for retrieving service management data associated with the customer, and
one or more instructions for generating, in response to the request, a user interface, where the user interface includes:
a time-based graphical representation of the business data,
a time-based graphical representation of the service management data, and
a linking object to link the graphical representation of the business data and the graphical representation of the service management data over a particular time period.

20. The computer-readable medium of claim 19, further comprising:
one or more instructions for providing, to the user device, formatting criteria to conform the business data to a format compatible with the user interface.
